(19) United States
(12) Patent Application Publication
(10) Pub. No.: US 2007/0268618 A1
(43) Pub. Date: Nov. 22, 2007

(54) REGULATING READ/WRITE TRANSDUCER MOVEMENT RESPONSIVE TO ACOUSTICS

(75) Inventors: Yanning Liu, San Ramon, CA (US); Franz Dierkes, Los Gatos, CA (US); David Tung, Livermore, CA (US)

Correspondence Address: Myers Bigel Sibley & Sajovec, P.A., P.O. Box 37428, Raleigh, NC, 27627, US

(73) Assignee: Seagate Technology LLC

(21) Appl. No.: 11/742,347

(22) Filed: Apr. 30, 2007

Related U.S. Application Data
(60) Provisional application No. 60/747,547, filed on May 18, 2006.

(51) Int. Cl. G11B 5/596; G11B 21/02

(52) U.S. Cl. 360/78.04; 360/75

(57) ABSTRACT

Various methods and circuits are described for controlling movement of a read/write transducer. The acoustics that are generated when moving a read/write transducer are detected. Movement of the transducer is regulated in response to the detected acoustics.

### RELATED APPLICATION

This application claims the benefit of and priority to U.S. Provisional Patent Application No. 60/747,547, filed May 18, 2006, the disclosure of which is hereby incorporated herein by reference as if set forth in its entirety.

### FIELD

The present invention generally relates to controlling movement of read/write transducers and, more particularly, to controlling transducer movement during seek operations.

### BACKGROUND

Disk drives are one type of digital data storage device which can store and retrieve large amounts of data in a fast and efficient manner. A typical disk drive includes a plurality of magnetic recording disks which are mounted to a rotatable hub of a spindle motor and rotated at a high speed. An array of read/write transducers is disposed adjacent to surfaces of the disks to transfer data between the disks and a host device. The transducers can be radially positioned over the disks by a rotary actuator and a closed loop servo system, and can fly proximate the surfaces of the disks upon air bearings.

A plurality of nominally concentric tracks can be defined on each disk surface. A preamp and driver circuit generates write currents that conducted through a transducer to selectively magnetize the tracks during a data write operation and amplifies read signals detected by the transducer from the selective magnetization of the tracks during a data read operation. A read/write channel and interface circuit are connected to the preamp and driver circuit to transfer the data between the disks and the host device.

The servo system can operate in two primary modes: seeking and track following. During a seek, a selected transducer is moved from an initial track to a target track on the corresponding disk surface. The servo system applies current to an actuator coil to first accelerate and then decelerate the transducer toward the destination track.

During the seek, the servo system may sequentially measure the actual velocity of the transducer and adjust the current in relation to velocity error (i.e., the difference between the actual velocity and a target velocity). As the transducer approaches the destination track, the servo system initiates a settle mode to bring the transducer to rest over the destination track within a selected settle threshold, such as a percentage of the track width from track center. Thereafter, the servo system enters the track following mode wherein the transducer is nominally maintained over the center of the destination track until another seek is performed.

As will be appreciated, a disk drive is primarily utilized to transfer data between the tracks of the disks and the host device. Such data transfer operations usually cannot occur during a seek, but rather require the drive to be in track following mode. Hence, to maximize disk drive data transfer rate capabilities, disk drives can attempt to obtain minimum average seek times. However, the forces that can be exerted on the actuator to obtain minimum average seek times can cause vibration of the actuator and the disk drive, and can result in a decrease in the seek performance and undesirable acoustical noise.

While some acoustic noise levels may be acceptable for a disk drive to generate while used with some types of host devices, such as inside personal computers, lower acoustic noise levels may be desired for other types of host devices, such as digital video recorder systems, picture/music recorder systems, and external data storage systems. The American National Standard ATA8-ACS defines 127 different automatic acoustic management (AAM) levels that disk drives may implement. However, disk drives that implement AAM levels are typically hardwired (e.g., via a jumper) or otherwise set to one of three different levels, which are typically a quiet acoustic level, a middle acoustic level, or a maximum acoustic level, by the manufacturer of the disk drive. Some disk drives may, for example, be capable of supporting the three AAM levels shown in FIG. 1, and which a manufacturer may select among by changing jumper settings and/or by programming registers in the disk drive. Accordingly, while the AAM level defined by a manufacturer may provide an acceptable noise level and performance for some use with some types of host devices, it may not be acceptable for other host devices.

### SUMMARY

Various embodiments are described for controlling movement of a read/write transducer. The acoustics that are generated when moving the transducer are detected. Movement of the transducer is regulated in response to the detected acoustics.

### DESCRIPTION OF THE DRAWINGS

FIG. 1 illustrates a table of exemplary AAM levels according to the ATA8-ACS standard.

FIG. 2 illustrates a block diagram of an exemplary computer system that includes a disk drive.

FIG. 3 illustrates a diagram of an exemplary head disk assembly of the disk drive.

FIG. 4 illustrates a block diagram of the drive electronics of the disk drive according to some embodiments of the present invention.

FIG. 5 illustrates a diagram of a disk drive that illustrates a seek operation according to some embodiments of the present invention.

FIG. 6 illustrates graphs of exemplary average seek time and sound power levels for a range of AAM levels.

FIG. 7 illustrates three graphs of exemplary sound power levels for ping-pong transducer seek operations from an inner diameter location, an outer diameter location, and a middle diameter location on a disk that a transducer is repetitively moved between (ping-pong movement) for a range of AAM levels.

FIG. 8 illustrates a graph of exemplary sound power spectra for a range of AAM levels when a transducer is moved 10,000 tracks from an inner diameter location on a disk and returned thereto (ping-pong seeking) as the AAM level increases from 128 to 254.

FIG. 9 illustrates a graph of exemplary sound power spectra for a range of AAM levels when a transducer is moved 10,000 tracks from an middle diameter location on a disk and returned thereto, (ping-pong seeking) as the AAM level increases from 128 to 254.

FIG. 10 illustrates a graph of exemplary seek current levels for a range of AAM levels when a transducer is moved from an inner diameter location to an outer diameter location on a disk and returned thereto (ping-pong seeking) as the AAM level increases from 128 to 254.

FIG. 11 illustrates a block diagram of the servo controller according to some embodiments of the present invention.

FIG. 12 is a flowchart of operations that may be carried out by the servo controller to regulate transducer movement in response to detected acoustics.

FIG. 13 illustrates a graph of a current command, provided to an actuator for a seek operation, that is magnitude regulated according to some embodiments of the present invention.

FIG. 14 illustrates a graph of a current command, provided to an actuator for a seek operation, that is magnitude and slope regulated according to some further embodiments of the present invention.

FIG. 15 illustrates a graph of a current command, provided to an actuator for a seek operation, that is magnitude and slope regulated according to some further embodiments of the present invention.

FIG. 16 is a flowchart of operations that may be carried out by the servo controller to reorder a command queue based on the expected acoustics that will be generated when seeking to carry out the commands.

FIG. 17 is flowchart of exemplary operations that may be carried out by a host and disk drive to select among a plurality of AAM levels in accordance with some embodiments.

### DETAILED DESCRIPTION

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will convey the scope of the invention to those skilled in the art. The terminology used in the detailed description of the particular exemplary embodiments illustrated in the accompanying drawings is not intended to be limiting of the invention.

It will be understood that, as used herein, the term “comprising” or “comprises” is open-ended, and includes one or more stated elements, steps and/or functions without precluding one or more unstated elements, steps and/or functions. As used herein, the singular forms “a”, “an” and “the” are intended to include the plural forms as well, unless the context clearly indicates otherwise. As used herein the terms “and/or” and “/” include any and all combinations of one or more of the associated listed items. It will be understood that, although the terms first, second, etc. may be used herein to describe various steps, elements and/or regions, these steps, elements and/or regions should not be limited by these terms. These terms are only used to distinguish one step/element/region from another step/element/region. Thus, a first step/element/region discussed below could be termed a second step/element/region without departing from the teachings. Like numbers refer to like elements throughout the description of the figures.

The present invention may be embodied in hardware and/or in software (including firmware, resident software, micro-code, etc.). Consequently, as used herein, the term “signal” may take the form of a continuous waveform and/or discrete value(s), such as digital value(s) in a memory or register.

The present invention is described below with reference to block diagrams of disk drives, disks, controllers, and operations according to various embodiments. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show what may be a primary direction of communication, it is to be understood that communication may occur in the opposite direction to the depicted arrows.

In accordance with some embodiments, the acoustics generated when moving a read/write transducer in a data storage device are detected, and movement of the transducer is regulated in response to the detected acoustics. Although many embodiments are described herein in the context of a magnetic disk drive for purposes of explanation, they are not limited thereto. Instead, various operations and circuits described herein may be carried out in other types of data storage devices, which may include, but are not limited to, optical disk drives, electro-optical disk drives, magnetic tape drives, and/or other types of data storage devices.

Referring to FIG. 2, an exemplary host device 10 is shown that can include, but is not limited to, a desktop computer, a laptop computer, a personal digital assistant (PDA), a digital video recorder/player, a digital picture/music recorder/player, and/or another electronic device that can be communicatively coupled to store and/or retrieve data in a disk drive 25. Although a single disk drive 25 is shown for simplicity, the host device 10 may be configured to store/retrieve data from a plurality of disk drives 25 such as within a computer server. The host device 10 may include a central processing unit (“CPU”) 14, a main memory 16, and I/O bus adapter 18, all interconnected by a system bus 20. Coupled to the I/O bus adapter 18 is I/O bus 22, that may be, for example, a small computer system interconnect (SCSI) bus, firewire bus, and/or a universal serial bus. The I/O bus 22 supports various peripheral devices 24 and a data storage unit such as a disk drive 25. The disk drive 25 includes drive electronics 26 and a head disk assembly 28 (“HDA”).

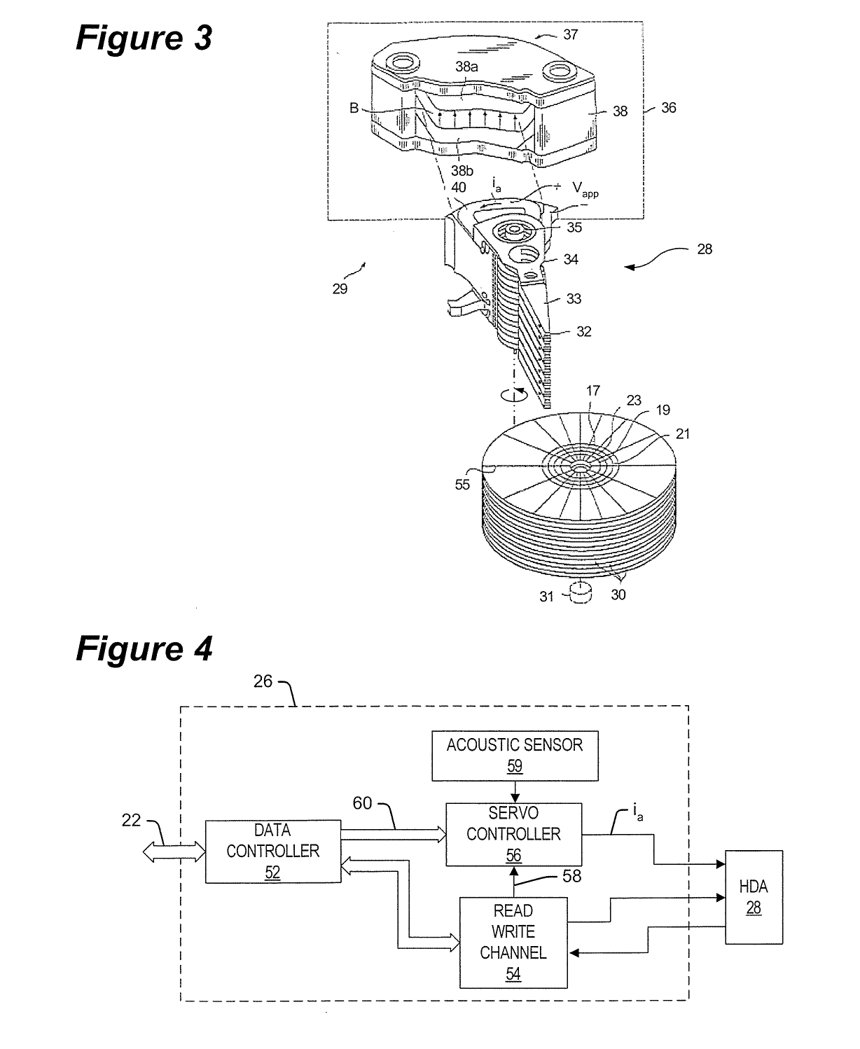

Referring to FIG. 3, an exemplary embodiment of the HDA 28 of FIG. 2 is shown that includes an actuator 29 and disks 30 that can be rotated by a spindle motor 31. Data can be stored on the disks 30 in concentric circular data tracks 17. The data can be written and read from the disks 30 via magnetic transducers 32 which are attached to flexible load beams 33 extending from actuator arms 34. The actuator arms 34 pivot about point 35 to move the load beams 33 in a radial direction over the storage surfaces of the disks 30 from an initial track 19 towards a target track 21 shown in FIG. 3 by example. At the target track 21, the magnetic transducers 32 can read from and/or write data on the disks 30. A motor 36 controls the radial movement of the actuator arms 34 in proportion to an input actuator current iₐ. Although the disks 30 are described as magnetic disks for purposes of illustration, the disks 30 may alternatively be optical disks or any other type of storage disk which can have data storage tracks defined on one or both of its storage surfaces.

The exemplary motor 36 can include a magnet 37 containing two plates 38a, 38b coupled together via a pair of sidewalls to form a flat toroidal shaped member 38. A wire coil 40 is disposed between the two plates 38a and 38b. The magnet 37 may generate a magnetic field B between the plates 38a and 38b. When the input actuator current iₐ is induced in the coil 40 disposed in the magnetic field B, a torque is produced on the actuator arms 34 resulting in radial motion of the arms 34 about pivot point 35. The polarity of the input actuator current iₐ determines the direction of radial motion of the actuator arms 34.

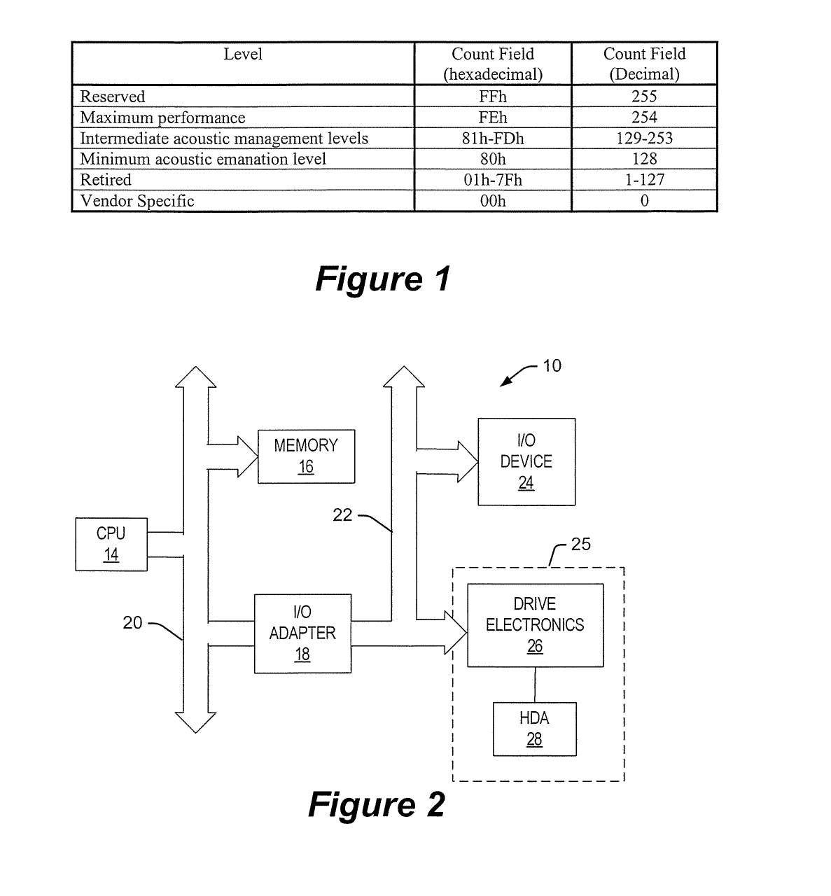

Referring to FIG. 4, the drive electronics 26 (FIG. 2) includes a data controller 52, a read/write channel 54, and a servo controller 56. A data transfer initiated by the CPU 14 to the disk drive 25 may involve, for example, a DMA transfer of data from the memory 16 onto the system bus 20 (FIG. 1). Data from the system bus 20 are transferred by the I/O adapter 18 onto the I/O bus 22. The data are read from the I/O bus 22 by the data controller 52, which formats the data into blocks with the appropriate header information and transfers the digital data to the read/write channel 54.

The read/write channel 54 can operate in a conventional manner to convert data between the digital form used by the data controller 52 and the analog form used by the transducers 32. For the transfer from the CPU 14 to the HDA 28, the read/write channel 54 converts the data to an analog form suitable for writing by a transducer 32 to the HDA 28. The read/write channel 54 also provides servo positional information read from the HDA 28 to the servo controller 56 on lines 58.

For example, the concentric data tracks 17 on the storage surface of a data disk 30 can be broken up and divided into segments by a multiplicity of regularly spaced apart embedded servo sectors 55 (FIG. 2). Each servo sector 55 can include transducer location information such as a track identification field and data block address, for identifying the track and data block, and burst fields to provide servo fine location information. The transducer location information can be used to detect the location of the transducer 32 in relation to that track and data block within the track. The transducer location information is induced into the transducer 32, converted from analog signals to digital data in the read/write channel 54, and transferred to the servo controller 56. The servo controller 56 can use the transducer location information for performing seek and tracking operations of the transducer 32 over the data tracks 17.

The data controller 52 also provides data that identifies the target track location and the addressed data block on lines 60 to the servo controller 56. The time to perform a seek from between an initial track to a target track is typically known as “seek time”. The servo controller 56 generates a current command that is converted into the input actuator current iₐ, and provided to the actuator 29 to radially move the transducer 32 across the disk 30. The seek time is thereby dependent on the magnitude of the current command and the slope of the leading edge and trailing edge of the current command (i.e., how quickly the current command is ramped-up and ramped-down).

Once the transducer 32 has reached the target track 21, the time required to rotate the disk 30 to a desired sector to perform a particular data access can be referred to as “rotational latency time,” or, more succinctly, “rotational latency.” The rotational latency can be the time required to rotate from a current position to a desired position on the disk 30. Thus, the rotational latency may be as great as the time required for one revolution of the disk 30. The rotational latency is dependent on the angular velocity of the disk 30, which is usually expressed in revolutions per minute (RPM). Generally, the total time to access an addressed data block on the disk 30 is about equal to the sum of the seek time, the rotational latency, and the time required to read or write the data.

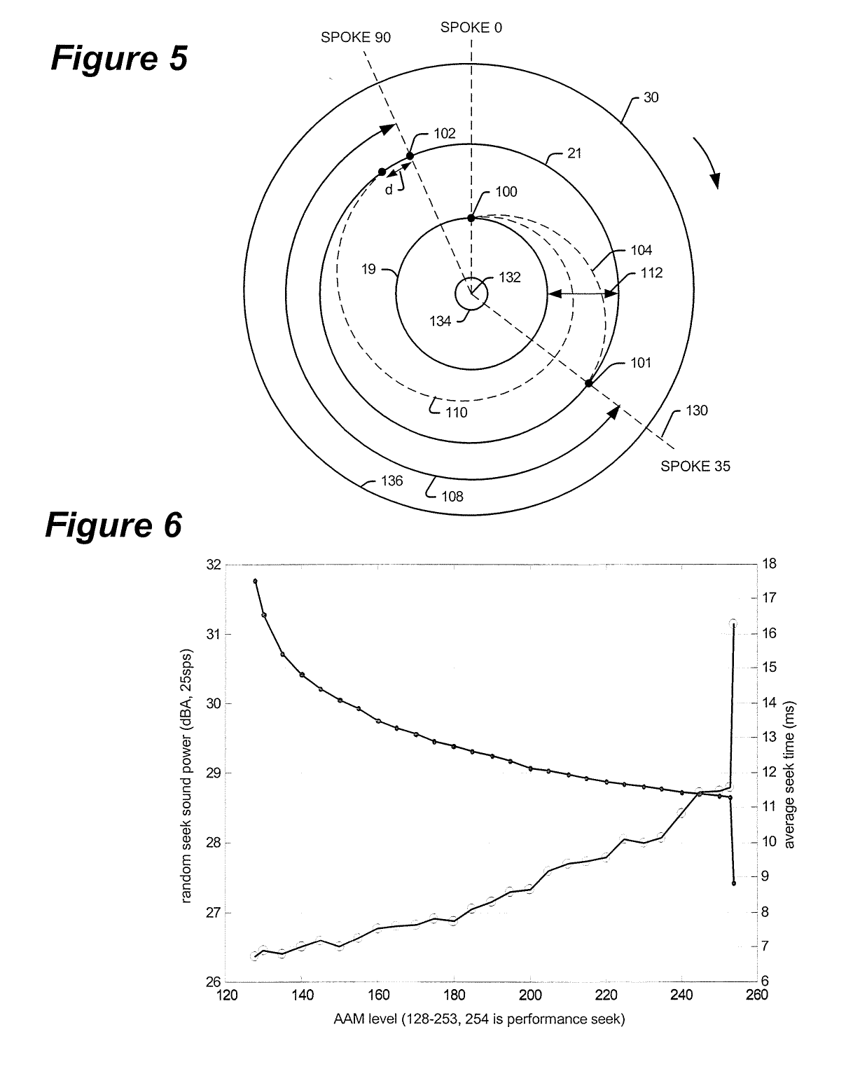

Referring now to FIG. 5, an exemplary one of the disks 30 is shown that illustrates a start location 100 of the transducer 32 (FIG. 2) on the initial track 19, and an addressed data block 102 on the target track 21 to which the CPU 14 has requested access. In one example seek operation, which may correspond to use of a maximum current command that corresponds to saturation of the motor 36, the servo controller 56 may move the transducer 32 along path 104 between the initial track 19 and the target track 21.

Strong acceleration and deceleration of the actuator 29 can cause significant vibration of the HDA 28 components and generate significant acoustical noise therefrom. In some embodiments, the acoustics that are generated when moving the transducer 32 are detected, and movement of the transducer 32 is regulated in response to the detect acoustics. For example, as shown in FIG. 4, the drive electronics 26 may further include an acoustic sensor 59 that generates an acoustic signal that is indicative of the sound level that is generated when the motor 36 and the actuator 29 move the transducer 32. The acoustic signal may be filtered by a filter 61 to remove noise that is not associated with sound generated by seek operations (e.g., pass-through components of the acoustic signal related to seeking).

The servo controller 56 may regulate the current command that is provided to the motor 36 in response to the acoustic signal from the acoustic sensor 59. The servo controller 56 may thus regulate the speed at which the motor 36 moves the transducer 32 to carry out seek operations based on a relative comparison of the acoustic signal to one or more defined acoustic threshold levels for the disk drive 25. For example, the servo controller 56 may slow down seek operations in response to the acoustic signal indicating that the sensed sound level exceeds one or more defined acoustic thresholds, such as one or more selected ones of the 127 different AAM levels defined by the American National Standard ATA8-ACS. Accordingly, the servo controller 56 may utilize a maximum current command to provide minimum seek times except when a seek operation results in the generation of acoustics that exceed one or more defined acoustic thresholds. In response to the sensed acoustics exceeding a defined acoustic threshold, the server controller 56 may slow down the seek operation by regulating the current command provided to the motor 36 to reduce the acceleration and/or deceleration of the transducer 32.

By regulating seek operations in response to the acoustic signal from the acoustic sensor 59, the disk drive 25 may be able to regulate its own acoustic generation, and may further be able to compensate for the acoustics that generated by other adjacent disk drives or other components of the host device system 10. For example, when the disk drive 25 is mounted with a plurality of other disk drives, such as in a data storage server, the disk drive 25 may reduce its acoustic generation by slowing down its seek operations so as to compensate for a spike in noise, as sensed by the acoustic sensor 59, from one or more adjacent drives that are, for example, spinning-up (e.g., powering-up), spinning-down (e.g., powering-down), and/or undergoing ping-pong seek operations between outer diameter and inner diameter disk locations.

Alternatively or additionally, the servo controller 56 may regulate the current command that is provided to the motor 36 in response to apriori knowledge of the acoustics that will be generated by seek operations. The servo controller 56 may include a seek acoustic table/function 63 that contains data that indicates estimated acoustic levels that the disk drive can generate while seeking various seek lengths from defined starting locations. Such apriori knowledge may be defined during the design and/or testing of the disk drive, and can be used to regulate the current command to reduce seek related acoustics.

In the exemplary minimum seek time operation, after seeking to the target track 21 along path 104, the disk 30 must continue to rotate an angular amount 108 (i.e. the rotational latency) before the transducer 32 reaches the addressed data block 102. The servo controller 56 regulates the current command based on the start location 100 of the transducer 32 and based on a location of the addressed data block 102 so that the generated acoustics do not exceed the defined acoustic threshold(s).

For example, when the defined acoustic threshold requires a minimum noise level, the servo controller 56 may regulate the current command so that the transducer 32 follows the trajectory along path 110 to reach the target track 21 a predetermined time/distance “d” before the addressed data block 102 reaches the transducer 32. The predetermined time/distance d may correspond to a typical time for the transducer 32 to settle on the target track 21 following a seek operation. In contrast, when the acoustics that are generated when seeking do not exceed an acoustic threshold, the servo controller 56 may move the transducer 32 along a trajectory that is not acoustically constrained, and may therefore supply a maximum current command to the motor 36 to move the transducer 32 to the target track 21 with a minimum seek time (e.g., along path 104).

Various acoustic threshold levels may be selected based, for example, on the 127 different AAM levels defined by the American National Standard ATA8-ACS. The selected acoustic threshold levels may cause the servo controller 56 to regulate the current command so that the transducer 32 follows trajectory paths that are within a range defined between the minimum time seek trajectory path 104 and the just-in-time seek trajectory path 110. The selected acoustic threshold levels may also cause the servo controller 56 to regulate the current command so that the transducer 32 follows a trajectory path that is longer than the just-in-time seek trajectory 110.

The disk 30 may be logically divided into a number of evenly spaced wedges or spokes 130 extending radially away from a center point 132 of the disk 30. Since the disk 30 rotates at a constant rotational speed, the number of spokes per unit time passing under the transducer 32 is also constant. Thus, times associated with the disk drive, such as seek times, latency times, delay times, etc., may be measured in terms of the number of spokes 130 passing under the transducer 32 during the period in question. For example, assuming a disk rotating at 10,000 revolutions per minute is divided into 100 spokes, then the time between spokes is 60 microseconds. Thus, a delay of 20 spokes corresponds to a delay of 1.2 milliseconds.

FIG. 6 illustrates graphs of exemplary average seek time and sound power levels for a range of AAM levels, which may occur when the disk drive 25 performs random seeks at a seek rate of 25 seeks per second. As shown in FIG. 6, a significant reduction in the acoustics that are generated by the disk drive 25 can be obtained by slowing down seek operations. For example, the faster seek operation occurs at an AAM level of 254, while decreasing seek operation speeds correspond to decreasing AAM levels. While the AAM level of 254 with the associated fast seek operations may be appropriate for some applications, such as within desktop computers, the quieter acoustics of lower AAM levels with corresponding slower seeks may be more appropriate for other applications, such as within digital video recorders.

The vibration force components that are generated by the motor 38 can increase as the transducer 32 nears an inner diameter 134 or an outer diameter 136 of the disk 30. A reason that seek operations near the middle diameter of the disk 30 are generally quieter than seek operations near the inner diameter 134 and outer diameter 136 of the disk 30 is related to the design of the motor 36. With reference to FIGS. 3 and 6, the magnetic field B near the end region of the plates 38a-b of the motor 36 may not be perpendicular to the wire coil 40 of the actuator 28. As a result, when the transducer 32 is proximate to the inner/outer diameter of the disk 30, the actuator 28 is near the edge, or transition zone, of the plates 38a-b. The magnetic field near the edge of the plates 38a-b is not entirely perpendicular to the coil 40 and, consequently, the forces on the coil 40 near the end region of the plates 38a-b may generate components that both rotate the actuator 28 and that shake the actuator 28 causing acoustic noise. Accordingly, acceleration/deceleration of the actuator 28 near the inner/outer diameter regions of the disk 30 can generate greater acoustic noise then equivalent acceleration/deceleration near a middle diameter region of the disk 30. In accordance with some further embodiments, the servo controller 56 may regulate movement of the transducer in response to the relative distance between the inner/outer diameter of the disk 30 and the start track and/or target track location of a seek operation.

When the disk drive 25 is used with some types of host devices, such as digital video recorder systems, the servo controller 56 may be commanded to repetitively move the transducer 32 at a relatively high frequency between two slowly varying spaced-apart radial locations, which can also be referred to as ping-pong seeking of the transducer 32. For example, when storing one video stream while reading another prerecorded video stream, the transducer 32 may bounce between tracks where the one video stream is being recorded and the other tracks where the other video stream is being retrieved. Such ping-pong seeking between the spaced-apart tracks may occur at a high frequency as the disk drive 25 intermittently stores and retrieves the two different video streams at their respective real-time video rates.

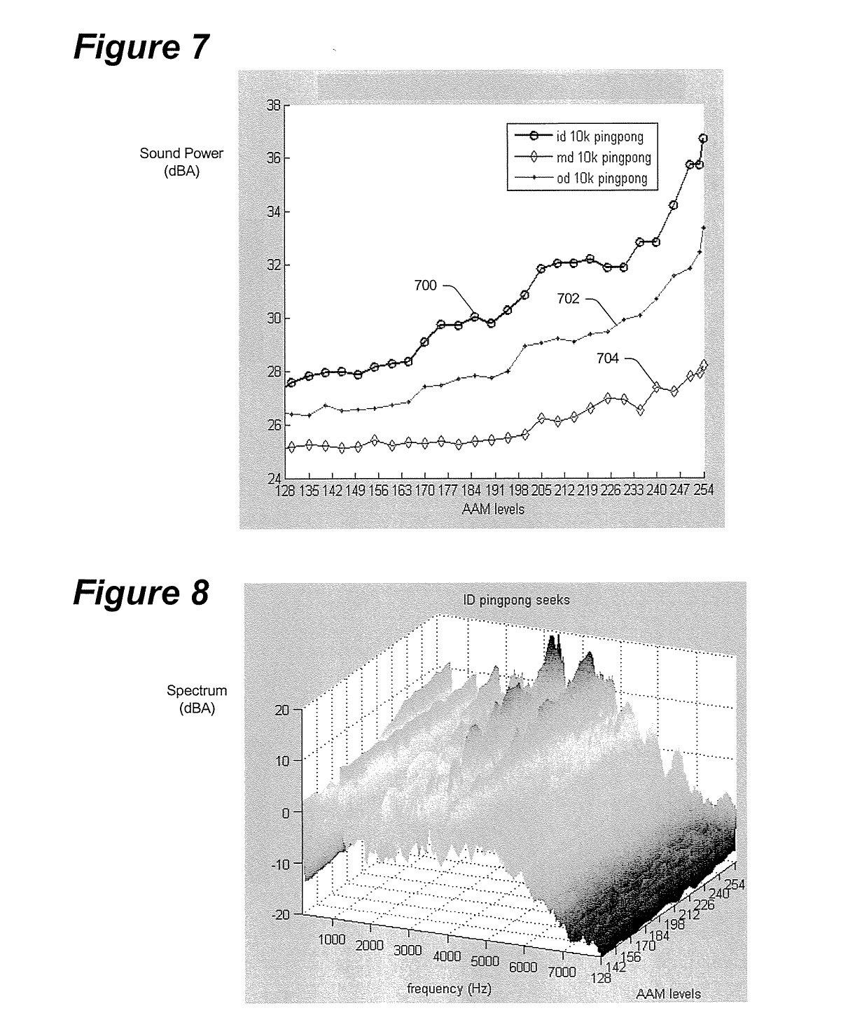

FIG. 7 illustrates three exemplary graphs of the sound that may be generated when repetitively ping-pong seeking a transducer according to various AAM levels from an inner diameter location, an outer diameter location, and a middle diameter location on a disk. Referring to FIG. 7, curve 700 illustrates seek operations that originate/arrive at the inner diameter 132 of the disk 30 generate the highest acoustic power levels. Curve 702 illustrates that seek operations that originate/arrive at the outer diameter 136 of the disk 30 generate the next highest sound power levels. Curve 704 illustrates that seek operations that originate/arrive at the middle diameter of the disk 30 generate lower acoustic power levels.

A customer's perception of what may be an acceptable acoustic level generated by the disk drive 25 is typically dependent upon the noisiest seek operations (i.e., the maximum sensed acoustic level), not the statistical averages of the acoustic levels. Accordingly, it may be desirable for the servo controller 56 to regulate movement of the transducer 32 so as to reduce the maximum acoustic level that is generated during seek operations.

FIG. 8 illustrates a graph of exemplary sound power spectra for a range of AAM levels when the transducer 32 is moved 10,000 tracks from an inner diameter (“ID”) location 134 on the disk 30 and returned thereto (ping-pong seeking) as the AAM level increases from 128 to 254. Referring to FIG. 8, the acoustic noise (“spectrum”) that may be generated by the disk drive 25 generally increases as the AAM level increases.

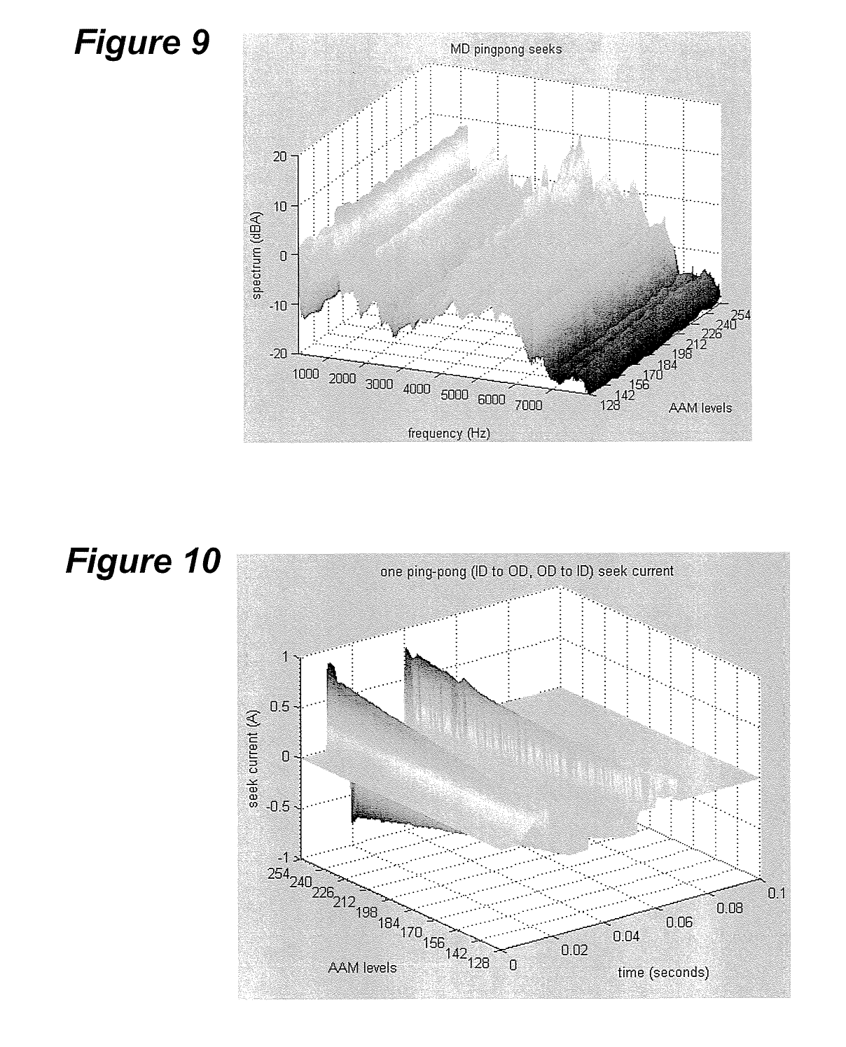

FIG. 9 illustrates a graph of exemplary sound power spectra for a range of AAM levels when the transducer 32 is moved 10,000 tracks from an middle diameter (“MD”) location on the disk 30 and returned thereto (ping-pong seeking) as the AAM level increases from 128 to 254. A comparison of FIGS. 8 and 9 shows that such ping-pong seek operations from an inner diameter location generally results in more acoustic noise than similar ping-pong seek operations from a middle diameter location on the disk 30.

FIG. 10 illustrates a graph of exemplary seek current levels for a range of AAM levels when the transducer 32 is moved from the inner diameter (“ID”) location 134 to the outer diameter (“OD”) location 136 on the disk 30 and returned thereto (ping-pong seeking) as the AAM level increases from 128 to 254. Referring to FIG. 10, ping-pong seek operations that are carried out at lower AAM levels may consume significantly less energy than ping-pong seek operations that are carried out at higher AAM levels. Accordingly, the disk drive 25 may not only operate quieter at lower AAM levels, but it may also consume less power and operate at lower temperatures.

The relationships between the starting track/target track for seek operations and the resulting acoustic power levels that are generated by the disk drive 25 may be determined by a manufacturer during the design and testing of a disk drive. These relationships may alternatively or additionally be defined or modified during operation the disk drive 25, such as by learning the acoustic signal levels are generated when seeking a transducer 32 various radial distances between starting tracks and target tracks on a disk. The servo controller 56 may then regulate the current command that is provided to the actuator 29 in response to the radial distance of the seek operation and further in response to the associated acoustic levels that are expected to generated thereby. The servo controller 56 may selectively regulate the current command when the acoustic level that will be generated during a seek operation is expected to exceed a threshold acoustic level, and/or may selectively regulate the current command in response to the acoustic sensor 59 sensing that the acoustic signal level that is generated during a seek operation has exceeded the threshold acoustic level.

As will be described in further detail below, the servo controller 56 may regulate the current command that is provided to the motor 36 in response to the acoustic signal from the acoustic sensor 59, and may further regulate the current command in response to the radial proximity of the transducer 32 to the inner/outer diameter 134/136 of the disk 30. The servo controller 56 may regulate the current command by constraining the magnitude of the current command to no more than a threshold level and/or by constraining the slope of the leading/trailing edge of the current command. For example, the servo controller 56 may reduce the maximum magnitude of the current command and/or reduce the maximum slope of the leading/trailing edge of the current command (i.e., reduce the rate at which the current command is ramped-up and/or ramped-down) when the start track/target track for a seek operation is within a threshold radial distance from the inner/outer diameter 134/136 of the disk 30.

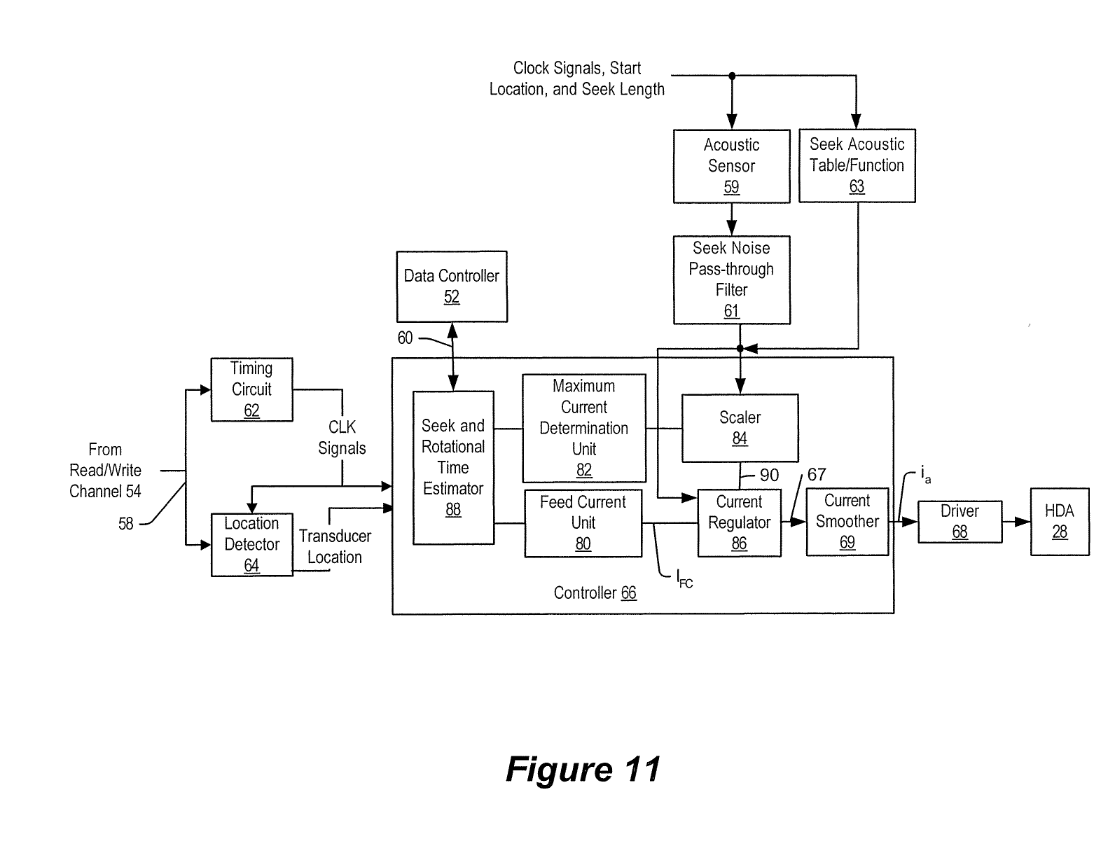

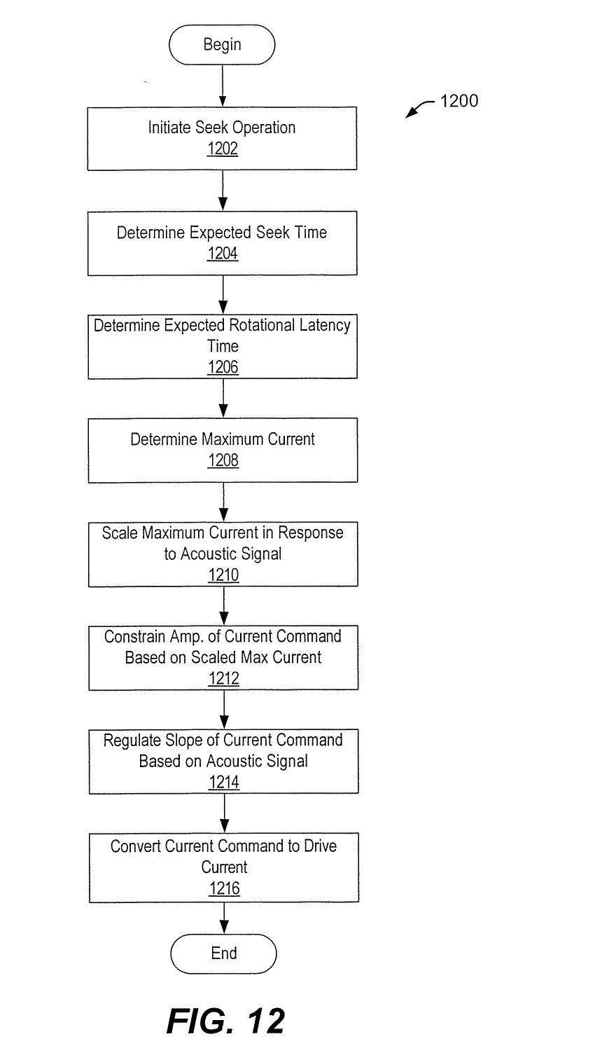

These and other aspects of the servo controller 56 are described with reference now to FIGS. 11 and 12 in accordance with some embodiments of the present invention. FIG. 11 illustrates a block diagram of the servo controller according to some embodiments of the present invention. FIG. 12 is a flowchart of operations 1200 that may be carried out by the servo controller to regulate transducer movement in response to detected acoustics.

The servo controller 56 can include a timing circuit 62, a location detector 64, a controller 66, and a driver 68. The timing circuit 62 can generate clock signals synchronized with the passage of servo sectors 55 on tracks under the transducer 32. The timing circuit 62 can include a counter and a phase locked loop for generating the clock signals. Based on the clock signals from the timing circuit 62 and transducer location data provided by the read/write channel 54, the location detector 64 detects a location of the transducer 32 relative to tracks on the disk 30 and data blocks within the tracks 17. The detected transducer location information in each servo sector 55 provides the address of the track which contains the servo sector 55, and therefore, the location of the transducer 32 relative to that track. The timing circuit 56 is synchronized with the read/write channel 54, and the location detector 64 receives the transducer location data from the read/write channel 54.

The controller 66 controls movement and positioning of the transducer 32 during seek operations. In response to clock signals from the timing circuit 62, where each clock signal indicates passage of a servo sector 55 under the transducer 32, the controller 66 obtains the transducer location information from the location detector 64. The controller 66 can include a feed current unit 80, a maximum current determination unit 82, a scaler 84, a current regulator 86, and a seek and rotational time estimator 88.

When a seek operation is initiated (Block 1202), the seek and rotational time estimator 88 determines an expected seek time (Block 1204) and determines an expected rotational latency time (Block 1206) based on the starting location of the transducer 32 and the location of the addressed data block 102. The expected seek time may be determined based on the initial track 19 and the target track 21. For example, the expected seek time may be selected from among a table of a plurality of seek parameters that associate distances (e.g., number of tracks from the initial track 19 to the target track 21) and corresponding expected seek times. Such a seek parameter table of seek distances and expected seek times may, for example, have common values that are used in multiple disk drives, rather than unique to each model of disk drive and/or a particular one of the disk drives. A seek distance 112 between the initial track 19 and the target track 21 is shown in FIG. 6. The expected rotational latency time may be determined based on an expected location of the transducer 32 after seeking to the target track 21 and based on the location of the addressed data block 102 (e.g., the expected rotation latency time corresponding to the angular amount 108).

The feed current unit 80 generates a feed current I_{FC} based on the expected seek time (i.e., based on the seek distance). For example, the feed current I_{FC} may be selected from among the seek parameter table that associates feed currents with corresponding expected seek times. In another example, the feed current I_{FC} may be determined based on a feed current profile that provides a feed current I_{FC} that varies based on distance from the target track.

The maximum current determination unit 82 is configured to determine a maximum current threshold I_{MAX} (Block 1208), which may be determined based on the initial track 19 and the target track 21 (i.e., the seek distance 112). For example, the maximum current threshold I_{MAX} may be selected from among the seek parameter table that associates a plurality of maximum currents and corresponding expected seek times. The maximum current threshold I_{MAX} may correspond to a level of the input actuator current iₐ where the motor 36 becomes saturated.

The scaler 84 scales (Block 1210) the maximum current threshold I_{MAX} in response to the acoustic signal from the acoustic sensor 59 to generate a scaled maximum current threshold 90. The scaler 84 may compare the acoustic signal to one or more defined acoustic threshold levels (e.g., a maximum allowed acoustic level) and reduce the scaled maximum current threshold 90 when the acoustic signal exceeds the acoustic threshold level. The scaler 84 may more continuously regulate the level of the scaled maximum current threshold 90 in response to changes in the acoustic signal from the acoustic sensor 59. For example, the scaler 84 may increase the scaled maximum current threshold 90, such as up to the saturation level of the motor 36, in response to decreased acoustic signal levels, and may decrease the scaled maximum current threshold 90 in response to increased acoustic signal levels.

The scaler 84 may alternatively or additionally scale the maximum current threshold I_{MAX} in response to the radial proximity of the initial track 18 and/or the target track 21 to the inner diameter 134 and/or the outer diameter 136 the disk 30. For example, the scaler 84 may increase the scaled maximum current threshold 90, such as up to the saturation level of the motor 36, in response to the initial track 18 and/or the target track 21 being at least a threshold distance from the inner diameter 134 and/or the outer diameter 136 the disk 30, and may correspondingly decrease the scaled maximum current threshold 90 in response to the initial track 18 and/or the target track 21 being less than the threshold distance from the inner diameter 134 and/or the outer diameter 136 the disk 30. The scaler 84 may more continuously regulate the level of the scaled maximum current threshold 90 in response to the proximity of the initial track 18 and/or the target track 21 to the inner diameter 134 and/or the outer diameter 136. The scaler 84 may thereby slow-down seek operations, or otherwise decrease acceleration/deceleration of the transducer 32, near the inner/outer disk diameters where the motor 36 is prone to cause increased acoustic noise.

The current regulator 86 is configured to constrain (Block 1212) the feed current I_{FC} based on the scaled maximum current threshold 90 to generate a regulated current command 67. For example, the current regulator 86 may limit the magnitude of the regulated current command 67 to no more than the scaled maximum current threshold 90. The regulated current command 67 is smoothed by a current smoother 69 (i.e., filter) to reduce/avoid sharp current transitions, which may otherwise cause abrupt actuator excitations that undesirably contribute to seek noise. The smoothed current command is converted (Block 1216) by the driver 68 to drive current iₐ and provided to the motor 36 in the HDA 28.

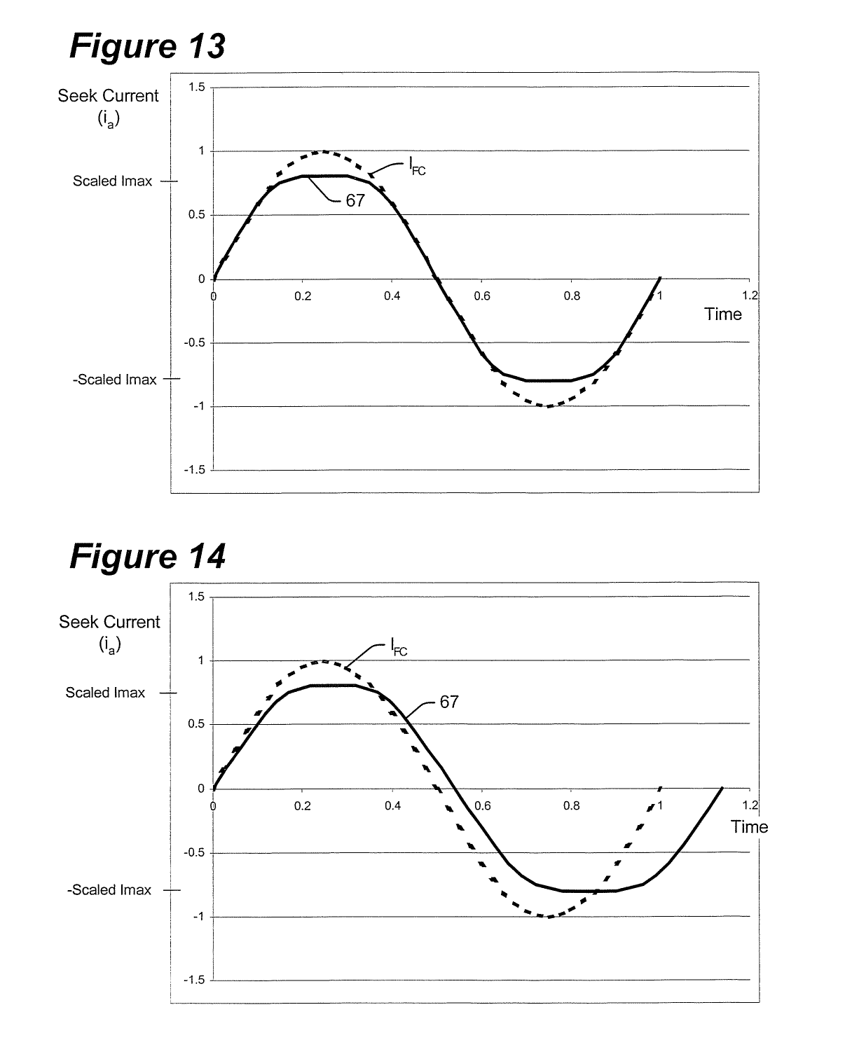

FIG. 13 illustrates a graph showing an exemplary unregulated feed current I_{FC} and regulated current command 67. The regulated current command 67 is constrained to be no more than the scaled maximum current 90 (“Scaled Imax”, “-Scaled Imax”). The portion of the unregulated feed current I_{FC} that is constrained in the regulated current command 67 is represented by the dashed lines.

The current regulator 86 may alternatively or additionally regulate (Block 1214) the slope of the leading/trailing edge of the feed current I_{FC} to generate the regulated current command 67. For example, the current regulator 86 may reduce the slope of the leading/trailing edge of the feed current I_{FC} (i.e., reduce the rate at which the regulated current command 67 is ramped-up and/or ramped-down) in response to the acoustic signal exceeding the acoustic threshold level and/or in response to the initial track 18 and/or the target track 21 being less than the threshold distance from the inner diameter 134 and/or the outer diameter 136 the disk 30. The current regulator 86 may more continuously regulate the slope of the leading/trailing edge of the regulated current command 67 in response to changes in the acoustic signal from the acoustic sensor 59 and/or in response to the proximity of the initial track 18 and/or the target track 21 to the inner diameter 134 and/or the outer diameter 136. The current regulator 86 may regulate the rate of change in the regulated current command 67 to reduce/avoid overly abrupt movement of the transducer during seeking, which could otherwise contribute to the seek acoustics.

FIG. 14 illustrates a graph showing an exemplary unregulated feed current I_{FC}, indicated by the dashed-line curve, and another regulated current command 67, indicated by the solid-line curve. In a similar manner to the regulated current command 67 of FIG. 13, the regulated current command 67 of FIG. 14 is constrained to be no more than the scaled maximum current 90 (“Scaled Imax”, “-Scaled Imax”). Moreover, the slope of the leading and trailing edges of the regulated current command 67 of FIG. 14 are constrained so that the rate at which the regulated current 67 ramps-up to scaled maximum current 90 and ramps-down from the scaled maximum current 90 is lower than that of the unregulated feed current I_{FC}. Accordingly, the scaler 84 and the current regulator 86 may cooperatively control the regulated current command 67 so that the regulated current command 67 more slowly ramps-up to the scaled maximum current 90 (“Scaled IMax”) than the unregulated feed current I_{FC}, and may thereby generate less acoustic noise as the transducer 32 is more slowly accelerated. The scaler 84 and the current regulator 86 also cooperatively control the regulated current command 67 so that the regulated current command 67 more slowly ramps-down to the negative scaled maximum current 90 (“-Scaled Imax”) than the unregulated feed current I_{FC}, and may thereby generate less acoustic noise as the transducer 32 is more slowly decelerated as it approaches the target track.

Although the regulated current command 67 is illustrated in FIGS. 13 and 14 as having a symmetrical acceleration portion (positive values) and deceleration portion (negative values), it is not limited thereto as it may have asymmetrical acceleration and deceleration portions. As described above, the servo controller 56 (e.g., via the scaler 84 and the current regulator 86) may dynamically control the regulated current command 67 in response to the acoustic signal from the acoustic sensor 59 and/or in response to the proximity of the starting track and/or target track of seek operations.

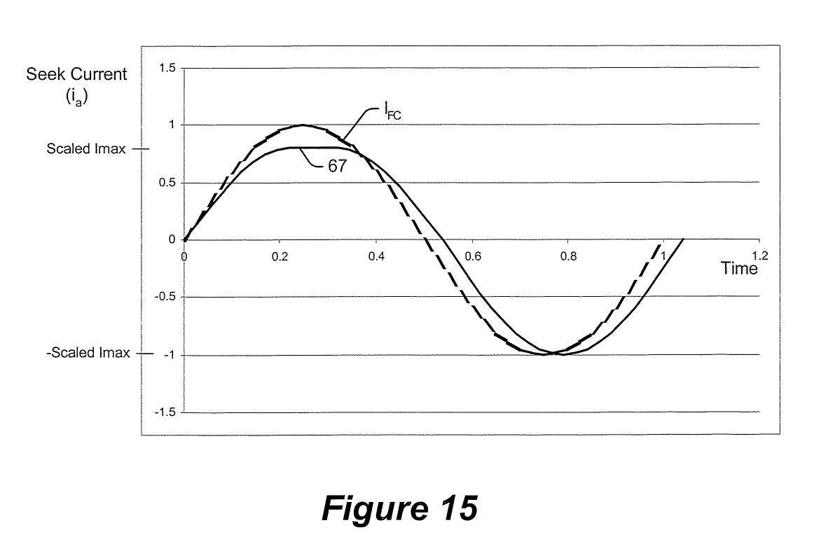

For example, FIG. 15 illustrates a graph showing an exemplary unregulated feed current I_{FC}, indicated by the dashed-line curve, and another regulated current command 67, indicated by the solid-line curve. The regulated current command 67 is controlled so as to have a more gradual acceleration slope up to the scaled maximum current 90 (“Scaled IMax”), which may be carried out to constrain the acoustics that are generated when the transducer 32 is seeking from a start location that is adjacent to the inner diameter 134 or the outer diameter 136 of the disk 30. The regulated current command 67 is subsequently controlled so as to more closely follow the shape of the unregulated feed current I_{FC}, and thereby have a more rapid deceleration slope down to a maximum negative value that exceeds, and, thereby, is not constrained by, the scaled maximum current 90 (“-Scaled IMax”). The regulated current command 67 is further controlled to closely follow the shape of the unregulated feed current I_{FC} as the regulated current command 67 slopes back to zero current as the transducer 32 reaches the target track. The servo controller 56 may provide the illustrated deceleration portion of the scaled maximum current 90 curve (with increased deceleration slope and/or magnitude that exceeds the scaled maximum current 90) when, for example, the target track is adjacent to the middle diameter of the disk 30, where the motor 36 may generate less vibration forces responsive to the current command iₐ.

Accordingly, as shown in FIG. 15, the servo controller 56 may control the regulated current command 67 so that the transducer 32 is more slowly accelerated from a starting location that is adjacent to the inner diameter 134 or the outer diameter 136 of the disk 30 than from a starting location that is proximate to the middle diameter of the disk 30. The servo controller 56 may similarly control the regulated current command 67 so that the transducer 32 is more slowly decelerated to a target location that is adjacent to the inner diameter 134 or to the outer diameter 136 of the disk 30 than from a target location that is adjacent to the middle diameter of the disk 30.

Accordingly, the scaler 84 and the current regulator 86 may regulate acceleration of the transducer 32 during seek operations, and may corresponding regulate of speed of seek operations to control the acoustic characteristics of the disk drive 25.

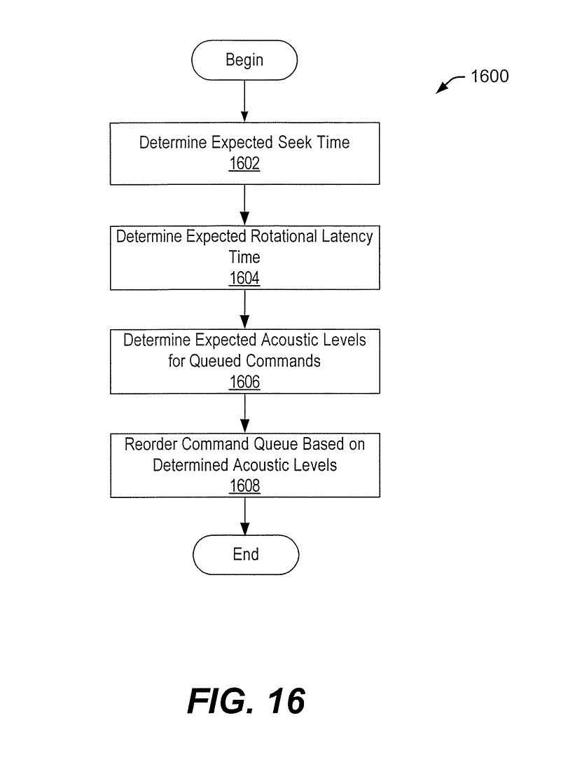

As was explained above, the data controller 52 may place read/write commands that are received from a host device into a queue, while the commands await execution by the disk drive 25. The order in which the queued commands is executed may follow a first-in first-out priority, such that commands are executed in the order that they are placed in the queue. However, in accordance with some further embodiments, the data controller 52 can reorder the priority with which the queued commands are carried out based on a prediction of the acoustics that will be generated when seeking the transducer 32 to carry out the queued commands. Exemplary operations (1600) for reordering queued commands will now be described with regard to the flowchart shown in FIG. 16.

Referring to FIG. 16, the expected seek time for the queued commands is determined (Block 1602), such as by the operations that were described above with regard to Block 1204 of FIG. 12. The expected rotational latency time for the queued commands is determined (Block 1602), such as by the operations that were described above with regard to Block 1206. The acoustic levels that are expected to be generated while seeking the transducer 32 for each of the queued commands are determined (Block 1606). The expected acoustic levels may be defined during manufacture/testing of the disk drive 25 and/or they may be learned by associated the acoustic signal levels that are sensed by the acoustic sensor 59 with the seek distance and/or location of the start/target tracks on the disk. The acoustic levels may be compared to one or more threshold levels, and, in response to the comparison, the queued commands may be reordered so as to reduce the acoustic levels that will be generated by one or more of the queued commands. For example, the queued commands may be reordered to reduce the seek distance between some adjacent commands in the queue to reduce the expected acoustics, or, for example, when the expected acoustics exceed one or more defined thresholds.

Accordingly, in some embodiments, the disk drive 10 includes a plurality of plurality of AAM levels within the disk drive 10 that be dynamically selected among on a seek-by-seek basis based on the characteristics of individual seek operations. A lower AAM level may therefore be selected that can meet defined data access time level while providing quieter seek operations. A host may control the disk drive 10 to select among the AAM levels (e.g., 125 to 254) that are available in the disk drive 10. For example, for a DVR application, when only one data stream is being written/read (e.g., a DVR which is recording a audio video stream), a low AAM level can be selected by the host to meet its performance requirements (e.g., providing occasional seek operations for operation system access while recording an audio video stream). As the host requires more performance out of the DVR, a higher AAM level can be selected to provide greater data input/output throughput.

Although a host may select one of the AAM levels (e.g., a high AAM level) for fast data access, the disk drive 10 may estimate the seek time and latency for individual seek operations and, based on those estimates, may instead choose a lower AAM level to perform the data access. The disk drive 10 may thereby regulate the seek acoustics based on the characteristics of individual seek operations.

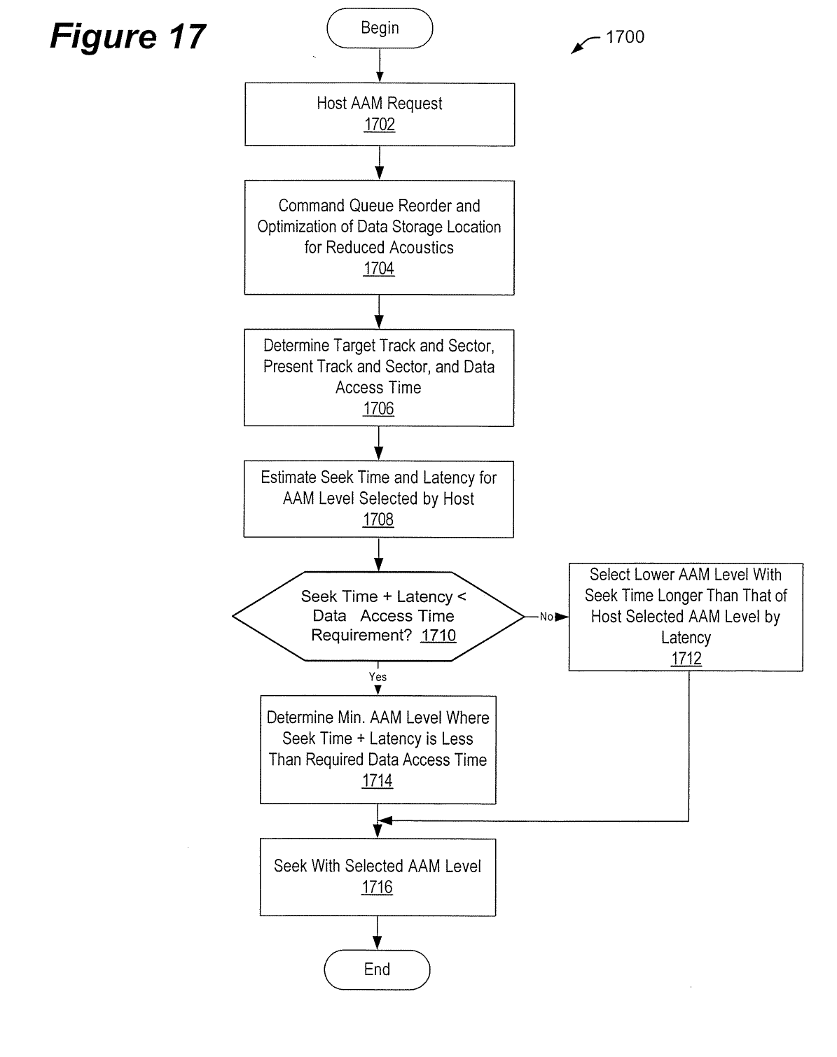

FIG. 17 is flowchart of exemplary operations 1700 that may be carried out by a host and the disk drive 10 to select among a plurality of AAM levels in accordance with some embodiments. Referring to FIG. 17, a host communicates (1702) an AAM level request to the disk drive 10. The data controller 52 may reorder (Block 1704) queued read/write commands to reduce resulting seek acoustics, and may further change/optimize where data is stored to further reduce resulting seek acoustics. For example, the queued commands may be reordered to reduce seek lengths, especially near inner diameter/out diameter locations. The data/servo controller 52/66 determines (Block 1706) the target track and sector, the present track and sector, and the data access time (seek time+latency) that is needed to meet read/write commands. The seek time and latency is estimated (Block 1708) for the AAM level selected by the host. A decision is made (Block 1710) whether the combined seek time and latency is less than the data access time requirement. If not, a lower AAM level can still be selected (Block 1712) with the minimum latency so that the data access time with the lower AAM is still the same as the AAM level requested by the host. Such selection may be carried out based on information in the seek acoustic table/function 63 described with regard to FIG. 11. When the combined seek time and latency is less than the data access time requirement, a minimum AAM level may be determined (Block 1714) for which the combined seek time and latency is less than the required data access time. The seek is then regulated (Block 1716) according to the selected AAM level.

Accordingly, in response to a host indicating a desired automatic acoustic management level, the disk drive 10 estimates a data access time for moving the transducer 32 in a seek operation, and regulates movement of the transducer 32 during the seek operation in response to the desired automatic acoustic management level and the estimating data access time. When the estimating data access time is less than the data access time determined for the desired automatic acoustic management level from the host, movement of the transducer 32 during the seek operation is regulated in response to a lower automatic acoustic management level providing a longer seek time than the desired automatic acoustic management level from the host device. In contrast, when the estimating data access time is greater than the data access time determined for the desired automatic acoustic management level from the host, movement of the transducer during the seek operation is regulated in response to an automatic acoustic management level for which the resulting data access time is no more than the data access time for the desired automatic acoustic management level from the host.

In some further embodiments, the disk drive 10 performs host requested AAM level seeks without carrying out an internal dynamic AAM adjustment or considering latency effects. The AAM level can be dynamically selected by the host based on the real data throughput to obtain lower noise generation, less power consumption and/or heat generation.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A method comprising:
detecting acoustics generated when moving a data read/write transducer; and
regulating movement of the transducer in response to the detected acoustics.

2. The method of claim 1, further comprising:
generating an acoustic signal that is indicative of sound generated when an actuator moves the transducer; and
regulating a current command provided to the actuator in response to the acoustic signal.

3. The method of claim 2, wherein regulating the current command comprises:
selecting among a plurality of seek parameters based on a radial distance between a starting track and a target track for a seek operation;
generating the current command in response to the selected seek parameters; and
scaling the current command in response to the acoustic signal.

4. The method of claim 2, wherein regulating the current command comprises:
regulating slope of a leading/trailing edge of the current command in response to the acoustic signal.

5. The method of claim 2, further comprising:
learning acoustic signal levels generated by transducer seek operations for a plurality of radial distances between starting tracks and target tracks; and
regulating the current command provided to the actuator in response to the radial distance of a seek operation and the associated learned acoustic signal level.

6. The method of claim 1, further comprising:
determining an expected seek time associated with moving the transducer from a starting track to a target track on a data storage disk;
determining an expected rotational latency time associated with rotating the disk to move an addressed data block on the target track adjacent to the transducer after the transducer would be expected to arrive at the target track;
selecting among a plurality of seek parameters based on the expected seek time and the expected rotational latency time;
generating an acoustic signal that is indicative of sound generated when the actuator moves the transducer; and
regulating movement of the transducer by the actuator in response to the selected seek parameters and in response to the acoustic signal.

7. The method of claim 1, further comprising:
limiting acceleration/deceleration of the transducer while seeking the transducer when a starting track and/or a target track is less than a threshold radial distance from the inner/outer diameter of a disk.

8. The method of claim 7, wherein limiting acceleration/deceleration of the transducer comprises limiting acceleration of the transducer while seeking the transducer when the starting track is less than a threshold radial distance from the inner/outer diameter of the disk, and limiting deceleration of the transducer while seeking the transducer when the target track is less than a threshold radial distance from the inner/outer diameter of the disk.

9. The method of claim 7, wherein limiting acceleration/deceleration of the transducer comprises reducing magnitude of a current command provided to an actuator to move the transducer when the starting track and/or the target track is less than a threshold radial distance from the inner/outer diameter of the disk.

10. The method of claim 7, wherein limiting acceleration/deceleration of the transducer comprises reducing slope of a leading/trailing edge of a current command provided to an actuator to move the transducer when the starting track and/or the target track is less than a threshold radial distance from the inner/outer diameter of the disk.

11. A circuit comprising:
a servo controller that regulates movement of a read/write transducer in response to acoustics detected when moving the transducer.

12. The circuit of claim 11, further comprising:
an acoustic sensor that generates an acoustic signal that is indicative of sound generated when an actuator moves the transducer,
wherein the servo controller regulates a current command provided to the actuator in response to the acoustic signal.

13. The circuit of claim 12, wherein the servo controller selects among a plurality of seek parameters based on a radial distance between a starting track and a target track on a data storage disk for a seek operation, generates the current command in response to the selected seek parameters, and scales the current command in response to the acoustic signal.

14. The circuit of claim 12, wherein the servo controller regulates slope of a leading/trailing edge of the current command in response to the acoustic signal.

15. The circuit of claim 12, wherein the servo controller learns acoustic signal levels generated by transducer seek operations for a plurality of radial distances between starting tracks and target tracks, and regulates the current command provided to the actuator in response to the radial distance of a seek operation and the associated learned acoustic signal level.

16. The circuit of claim 11, wherein the servo controller reduces magnitude of a current command provided to an actuator to move the transducer when the starting track and/or the target track is less than a threshold radial distance from the inner/outer diameter of the disk.

17. The circuit of claim 11, wherein the servo controller reduces slope of a leading/trailing edge of a current command provided to an actuator to move the transducer when the starting track and/or the target track is less than a threshold radial distance from the inner/outer diameter of the disk.

18. A method comprising:
receiving a signal from a host device indicating a desired automatic acoustic management level;
estimating a data access time for moving a transducer in a seek operation; and
regulating movement of the transducer during the seek operation in response to the desired automatic acoustic management level and the estimating data access time.

19. The method of claim 18, further comprising:
determining a data access time for moving the transducer based on the desired automatic acoustic management level from the host device;
when the estimating data access time is less than the data access time determined for the desired automatic acoustic management level from the host device, regulating movement of the transducer during the seek operation in response to a lower automatic acoustic management level providing a longer seek time than the desired automatic acoustic management level from the host device.

20. The method of claim 19, further comprising:
when the estimating data access time is greater than the data access time determined for the desired automatic acoustic management level from the host device, regulating movement of the transducer during the seek operation in response to an automatic acoustic management level for which the resulting data access time is no more than the data access time for the desired automatic acoustic management level from the host device.

21. A method comprising:
within a host, selecting an automatic acoustic management level based on disk drive data input/output throughput requirements, disk drive power consumption requirements, disk drive heat generation requirements, and/or disk drive seek acoustic requirements;
within a disk drive, receiving a signal from the host device indicating the automatic acoustic management level; and
regulating movement of a transducer within the disk drive during a seek operation in response to the automatic acoustic management level.
